(19) United States
(12) Patent Application Publication
(10) Pub. No.: US 2012/0077383 A1
(43) Pub. Date: Mar. 29, 2012

(54) ELECTRICAL CONNECTOR WITH AN IDENTIFICATION LAYER

(75) Inventor: Song Chen, Shen Zhen (CN)

(73) Assignee: HON HAI PRECISION INDUSTRY CO., LTD., New Taipei (TW)

(21) Appl. No.: 13/233,020

(22) Filed: Sep. 15, 2011

(30) Foreign Application Priority Data
Sep. 23, 2010 (CN) 201020540532.1

(51) Int. Cl. H01R 13/40

(52) U.S. Cl. 439/625

(57) ABSTRACT

An electrical connector includes a first housing and a second housing assembled to the first housing, the first housing and the second housing forming a receiving room. The electrical connector also includes a plurality of contacts retained in the first housing and each contact includes a contact portion located in the receiving room, a retaining portion and a soldering portion extending out of the receiving room. The contact portion protrudes out of the top face of the first housing. A top face of the first housing defines an identification layer by printing.

### BACKGROUND OF THE INVENTION

1. Field of the invention

The present invention relates to an electrical connector, and more particularly to an electrical connector with an identification layer.

2. Description of the related art

U.S. Pat. No. 7,559,791 issued on Jul. 14, 2009 discloses an electrical connector includes a body and a plurality of contact pins inserted into the body. The electrical connector further includes an identification layer retained on an inner face of a bottom wall of the body. The process of retaining the identification layer to the body is complicated.

In view of the above, a new electrical connector that overcomes the above-mentioned disadvantages is desired.

### SUMMARY OF THE INVENTION

Accordingly, an object of the present invention is to provide an electrical connector with an identification layer.

To fulfill the above-mentioned object, an electrical connector comprises a first housing and a second housing assembled to the first housing, the first housing and the second housing forming a receiving room. The electrical connector also comprises a plurality of contacts retained in the first housing and each contact comprising a contact portion located in the receiving room, a retaining portion and a soldering portion extending out of the receiving room, the contact portion protrudes out of the top face of the first housing. Wherein a top face of the first housing forms a identification layer by printing.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector of the present invention;

FIG. 2 is a part exploded view of the second housing of the electrical connector of FIG. 1;

FIG. 3 is a top perspective view of the electrical connector of FIG. 1; and

FIG. 4 is an exploded view of the electrical connector of FIG. 1.

### DETAILED DESCRIPTION OF THE PREFERRED EMBODIMENT OF THE INVENTION

Reference will now be made to the drawings to describe the present invention in detail.

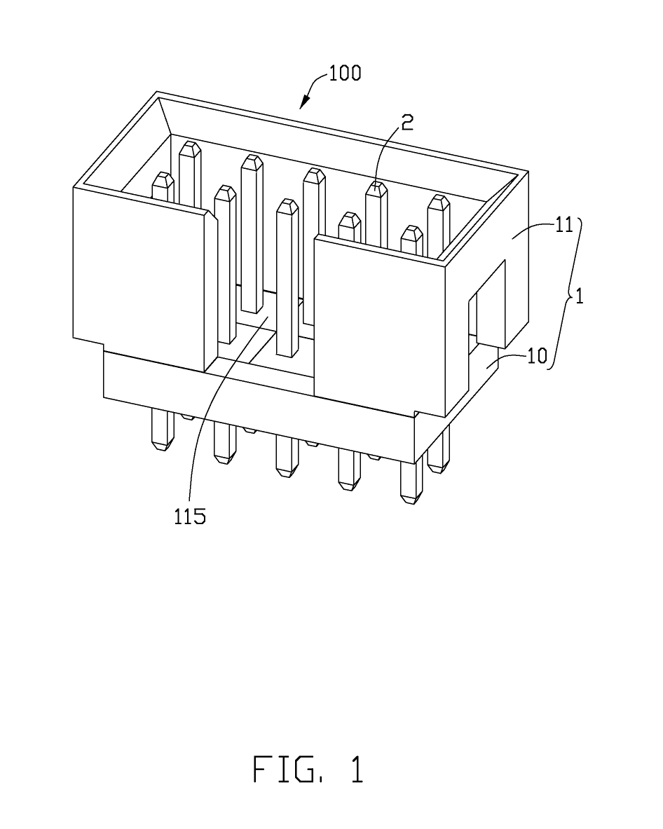

Referring to FIGS. 1, an electrical connector 100 in accordance with an embodiment of the present invention comprises an insulative housing 1 and a plurality of contacts 2 secured in the insulative housing 1. The insulative housing 1 includes a first housing 10 and a second housing 11 assembled to the first housing 10. The first housing 10 and the second housing 11 commonly define a receiving room 115 thereamony.

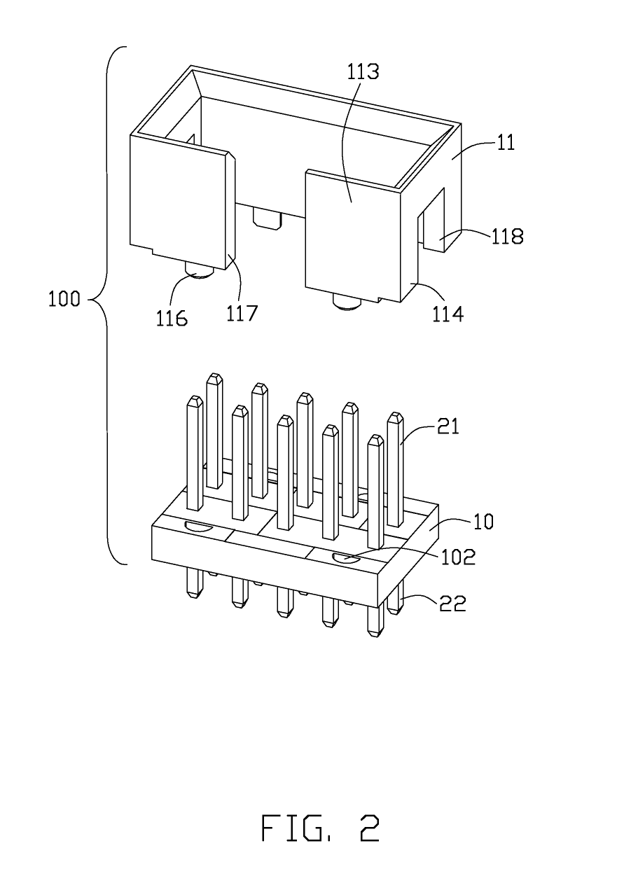

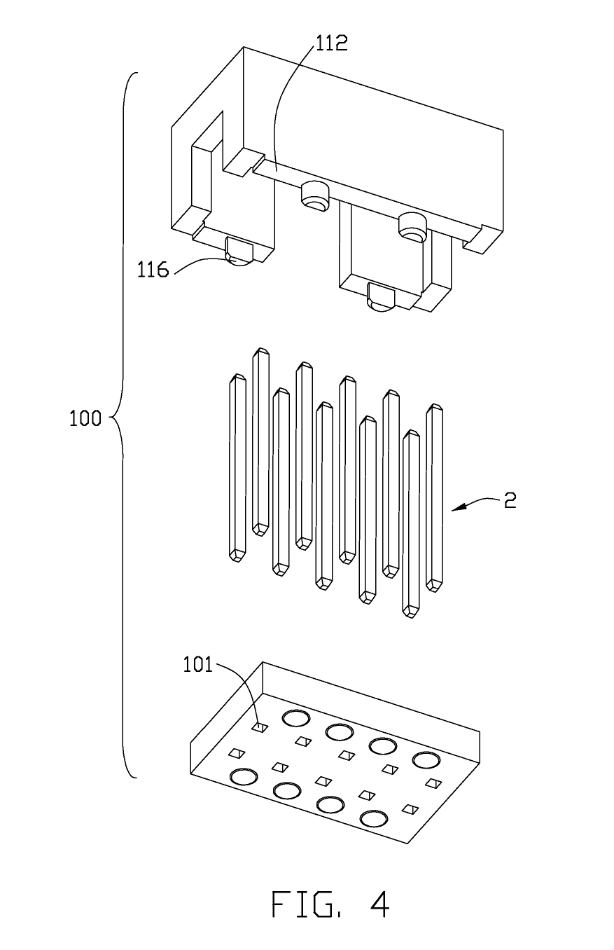

Referring to FIGS. 2 and FIGS. 4, the first housing 10 is configured with a board shape and defines a plurality of passageways 101 extending through in a up-to-down direction for retaining the contacts 2 and a plurality of retaining grooves 102 recessed from a top surface thereof The second housing 11 abuts against the top surface of the first housing 10. The second housing 11 is configured with a rectangle shape and defines a pair of longwise side walls 113, a pair of shorter side walls 114 and a mounting surface 112. A plurality of poles 116 is protruded downwardly from the mounting surface 112 and is inserted into the retaining grooves 102. The pole 116 and the retaining groove 102 are configured with a semicircle shape. One of the longwise side walls defines a cutout 117 extending through in the up-to-down direction and the two shorter side walls respectively defines a U-shaped opening 118 extending through downwardly for easy to assemble the second housing 11 to the first housing 10.

Referring to FIGS. 2 and FIGS. 4, the contacts and the first housing 10 is configured with a cross shape. Each contact is defined a pole shape and comprises a contact portion 21 located in the receiving room 115 and protruding out of the top surface of the first housing 10, a retaining portion retained in the first housing 10 and a soldering portion 22 extending out of the receiving room 115.

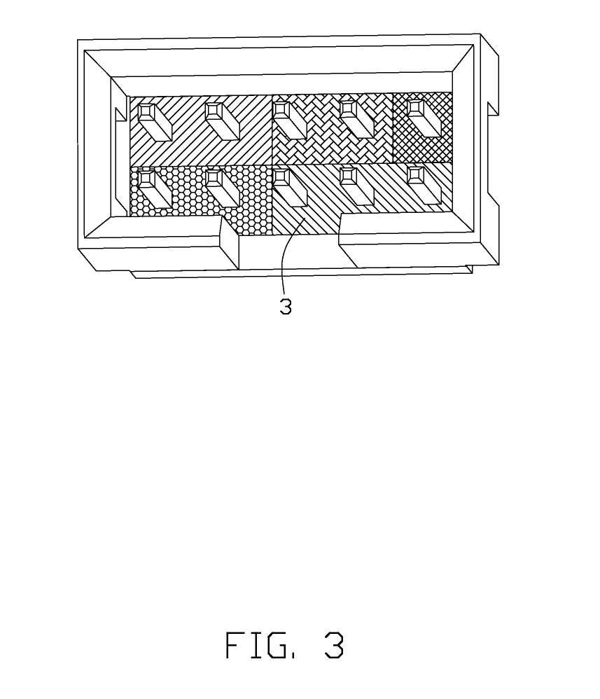

Referring to FIGS. 3, the top surface of the first housing 10 forms a identification layer 3 by printing. The identification layer 3 is divided into a plurality of different areas. The contacts 2 are assembled in the first housing 10 and protrude out of different areas for transforming different signals. Finally, the second housing 11 is assembled to the first housing 10. It is favorable for printing the identification layer and cost down.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a first housing and a second housing assembled to the first housing, the first housing and the second housing forming a receiving room;
a plurality of contacts retained in the first housing and each contact comprising a contact portion located in the receiving room, a retaining portion and a soldering portion extending out of the receiving room, the contact portion protrudes out of a top face of the first housing;
wherein the top face of the first housing forms an identification layer by printing.

2. The electrical connector as claimed in claim 1, wherein the second housing abuts against the top face of the first housing.

3. The electrical connector as claimed in claim 2, wherein the top face of the first housing defines a plurality of retaining grooves, the second housing protrudes a plurality of retaining poles inserted into the retaining grooves.

4. The electrical connector as claimed in claim 3, wherein the retaining pole is configured with a semicircle shape.

5. The electrical connector as claimed in claim 1, wherein the contact and the first housing are configured with a cross shape.

6. The electrical connector as claimed in claim 5, wherein the contact is configured with a pole shape and the first housing is configured with a board shape.

7. The electrical connector as claimed in claim 1, wherein the second housing is configured with a rectangle shape, one longwise side wall of the second housing defines a cutout extending through in an up-to-down direction.

8. The electrical connector as claimed in claim 7, wherein two shorter side walls of the second housing respectively defines a U-shaped opening extending through downwardly.

9. The electrical connector as claimed in claim 1, wherein the identification layer is divided into a plurality of different areas, the contacts protruding out of different areas transform different signals.

10. An electrical connector for mating with a complementary connector, comprising:
a first part defining a frame like body along a front-to-back direction with a therein mating cavity forwardly communicating with an exterior;
a second part discrete from while assembled to the first part; and
a plurality of contacts associated with the second part with forwardly extending mating sections exposed into the mating cavity for mating with; wherein
a front face of the second part is proximal behind the mating face under condition that said front face is categorized with different areas corresponding to the contacts and said different areas are provided with thereon different identification units viewable and identifiable in the front-to-back direction from the exterior.

11. The electrical connector as claimed in claim 10, wherein said identification units are applied with different colors.

12. The electrical connector as claimed in claim 10, wherein said second part defines a unitary insulative block through which said contacts extend.

13. The electrical connector as claimed in claim 12, wherein the frame like body is assembled to the unitary insulative block in the front-to-back direction.

14. The electrical connector as claimed in claim 13, wherein a latching device is formed between the frame like body and the unitary insulative block in the front-to-back direction.

15. The electrical connector as claimed in claim 10, wherein the contacts defines mounting sections located behind the second part in the front-to-back direction.

16. The electrical connector as claimed in claim 10, wherein the contacts are assembled into the second part parallel to the front-to-back direction.
